(19) United States
(12) Patent Application Publication
(10) Pub. No.: US 2015/0331531 A1
(43) Pub. Date: Nov. 19, 2015

(54) INPUT DEVICE

(71) Applicant: Panasonic Intellectual Property Management Co., Ltd., Osaka (JP)

(72) Inventors: Toshiyuki AOYAMA, Osaka (JP); Shuji INOUE, Osaka (JP); Manabu INOUE, Osaka (JP); Shigeo KASAHARA, Hyogo (JP); Hiroyuki KADO, Osaka (JP); Naoki KOSUGI, Kyoto (JP); Kazushige TAKAGI, Osaka (JP); Akira TOKAI, Tokyo (JP); Takahito NAKAYAMA, Tokyo (JP)

(21) Appl. No.: 14/806,695

(22) Filed: Jul. 23, 2015

Related U.S. Application Data
(63) Continuation of application No. PCT/JP2014/001570, filed on Mar. 19, 2014.

(30) Foreign Application Priority Data
Mar. 25, 2013 (JP) 2013-061409

(51) Int. Cl. G06F 3/041; G06F 3/046; G02F 1/1333; G06F 3/044

(52) U.S. Cl. CPC G06F 3/0412; G06F 3/044; G06F 3/046; G02F 1/13338; G06F 2203/04103; G06F 2203/04112

(57) ABSTRACT

An input device according to the technology disclosed herein is one which is disposed on a user side of a display device, and includes a pair of coordinate detection electrodes that are disposed to face each other via a dielectric element. One of the pair of the coordinate detection electrodes is disposed on flexible film bonded on a surface on the user side of the display device. Electrodes of the display device serve as the other of the pair of the coordinate detection electrodes. Flexible film includes an extension part which extends from a detection region where the one of the coordinate detection electrodes is disposed. The extension part includes wiring parts which electrically couple to the coordinate detection electrodes and electrically and mechanically couple to connection parts that are disposed on the display device.

### TECHNICAL FIELD

The technology disclosed herein relates to input devices of an electrostatic-capacitive coupling type in which coordinate information is inputted into display screens.

### BACKGROUND ART

Display devices equipped with input devices having a screen input function where information is inputted into their display screens via touch operation by a user's finger, are used in devices including: mobile electronic devices such as PDAs and mobile terminals, a wide range of consumer electric appliances, and stationary customer-guiding terminals such as unmanned reception machines. Some systems of such input devices operable by touch input have been known, including: a resistance film system to detect resistance variations of a touched portion, an electrostatic-capacitive coupling system to detect capacitance variations of the touched portion, and an optical sensor system to detect light quantity variations of the touched portion that is shielded by the touch.

The electrostatic-capacitive coupling system has the following advantages over the resistance film system and the optical sensor system. That is, for example, the resistance film and optical sensor systems exhibit a low optical transmittance of around 80%, whereas the electrostatic-capacitive coupling system exhibits a high optical transmittance of approximately 90%, resulting in no degradation in display quality. Moreover, in the resistance film system, a touch position is detected via mechanical contact with a resistance film, leading to possible deterioration of or damage to the resistance film. In contrast, in the capacitive coupling system, a detection electrode is subjected to no mechanical contact with other electrodes, resulting in the advantage in view of durability.

For the input device of the electrostatic-capacitive coupling system, the system disclosed in Japanese Patent Unexamined Publication No. 2011-227923 is known, for example.

### SUMMARY

An input device according to the technology disclosed herein is one that is disposed on the user side of a display device, and that includes a pair of coordinate detection electrodes which are disposed to face each other via dielectric elements. One of the pair of the coordinate detection electrodes is disposed on a flexible film which is bonded on the surface on the user side of the display device. Electrodes of the display device serve as the other of the pair of the coordinate detection electrodes. The flexible film includes an extension part which extends from a detection region where the one of the coordinate detection electrodes is disposed. The extension part includes wiring parts which electrically couple to the coordinate detection electrodes and electrically and mechanically couple to connection parts disposed in the display device.

### BRIEF DESCRIPTION OF DRAWINGS

FIG. 1 is a configuration view illustrating a schematic configuration of a liquid crystal display device equipped with a touch panel according to an embodiment of the technology disclosed herein.

FIG. 2 is a cross-sectional view of the configuration of the liquid crystal display device equipped with the touch panel according to the embodiment of the technology.

FIG. 3A is a plan view of an example of an electrode pattern and connection parts, which both configure the touch panel, in the liquid crystal display device equipped with the touch panel according to the embodiment of the technology.

FIG. 3B is a plan view of an example of the electrode pattern and the connection parts, which both configure the touch panel, in the liquid crystal display device equipped with the touch panel according to the embodiment of the technology.

FIG. 4 is a plan view of a state of assembling of the liquid crystal display device equipped with the touch panel according to the embodiment of the technology.

FIG. 5A is a cross-sectional view illustrating a step of a manufacturing process of the liquid crystal display device equipped with the touch panel according to the embodiment of the technology.

FIG. 5B is a cross-sectional view illustrating a step of the manufacturing process of the liquid crystal display device equipped with the touch panel according to the embodiment of the technology.

FIG. 5C is a cross-sectional view illustrating a step of the manufacturing process of the liquid crystal display device equipped with the touch panel according to the embodiment of the technology.

FIG. 5D is a cross-sectional view illustrating a step of the manufacturing process of the liquid crystal display device equipped with the touch panel according to the embodiment of the technology.

FIG. 5E is a cross-sectional view illustrating a step of the manufacturing process of the liquid crystal display device equipped with the touch panel according to the embodiment of the technology.

FIG. 6 is a cross-sectional view of an exemplified configuration in which transparent electrodes are formed directly on a light-transmissive substrate.

FIG. 7 is a cross-sectional view illustrating a configuration of a liquid crystal display device equipped with a touch panel according to another embodiment of the technology disclosed herein.

FIG. 8 is a cross-sectional view illustrating a configuration of a liquid crystal display device equipped with a touch panel according to still another embodiment of the technology disclosed herein.

FIG. 9 is a cross-sectional view illustrating a configuration of a liquid crystal display device equipped with a touch panel according to yet another embodiment of the technology disclosed herein.

### DESCRIPTION OF EMBODIMENTS

Hereinafter, embodiments of a touch panel, i.e. an input device according to the technology disclosed herein, will be described with reference to the accompanying drawings. It is noted, however, that descriptions in more detail than necessary will sometimes be omitted. For example, detailed descriptions of well-known items and duplicate descriptions of substantially the same configuration will sometimes be omitted, for the sake of brevity of the following descriptions and easy understanding by those skilled in the art.

Note that the present applicant provides the accompanying drawings and the following descriptions so as to facilitate fully understanding of the present disclosure by those skilled in the art. The applicant in no way intends for these drawings and descriptions to impose any limitation on the subject matter described in the appended claims.

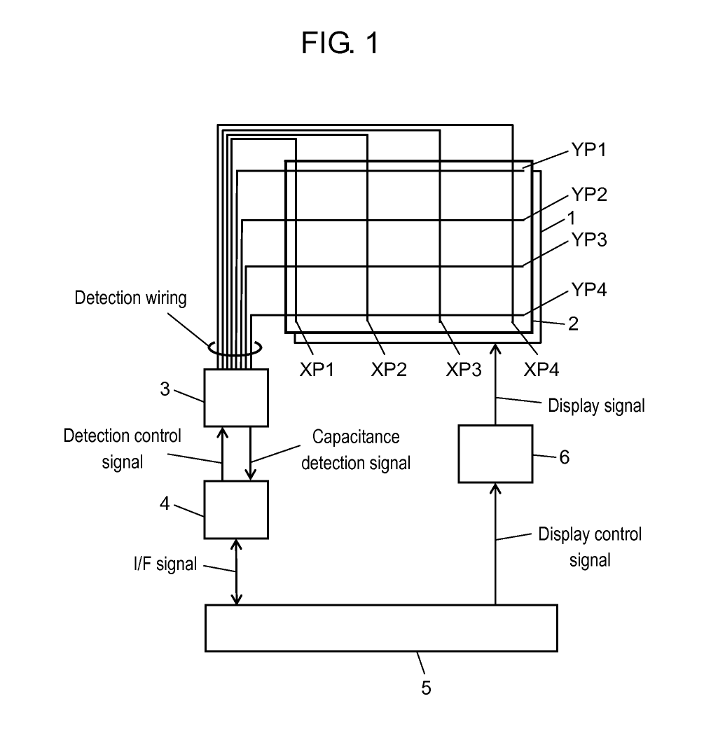

FIG. 1 is a configuration view illustrating the schematic configuration of a liquid crystal display having a touch panel function, according to an embodiment of the technology disclosed herein.

Liquid crystal display device 1 is a display device which has the touch panel function of an electrostatic-capacitive coupling system, for serving as an input device.

Touch panel substrate 2 is a light-transmissive substrate disposed on the user side of liquid crystal display device 1, i.e. on the front surface of liquid crystal display device 1. Touch panel substrate 2 has a rectangular flat-plate shape.

On touch panel substrate 2, detection electrodes YP1, YP2 . . . for detecting capacitance are formed which serve as one of a pair of coordinate detection electrodes. On the other hand, drive electrodes XP1, XP2 . . . for detecting the capacitance, which serve as the other of the pair of the coordinate detection electrodes, are employed with electrodes of the liquid crystal display device. That is, the electrodes of liquid crystal display device 1, such as common electrodes formed on a TFT substrate or pixel electrodes disposed for each pixel, serve as the other of the pair of the coordinate detection electrodes of the touch panel, i.e. drive electrodes XP1, XP2 . . . .

With liquid crystal display device 1 having the touch panel function, a user operates the touch panel while looking at a displayed image, which requires that the displayed image pass through touch panel substrate 2. Accordingly, touch panel substrate 2 is desired to have a high optical transmittance.

Detection electrodes YP1, YP2 . . . and drive electrodes XP1, XP2 . . . , which both configure the touch panel function, are coupled with capacitance detection unit 3 via detection wirings. Capacitance detection unit 3 is controlled by a detection control signal output from control computing unit 4, and detects capacitance formed between each of drive electrodes XP1, XP2 . . . and each of detection electrodes YP1, YP2 . . . included in the touch panel. The capacitance detection unit produces a capacitance detection signal which varies in accordance with a capacitance value of each electrode, and outputs the resulting signal to control computing unit 4.

Control computing unit 4 computes a signal component of each electrode from the capacitance detection signal of the each electrode. Using the signal component of the each electrode, the control computing unit 4 computes and determines the input coordinates. Upon receiving the input coordinates of the touch operation, which are transferred from control computing unit 4, control system 5 generates a display image in accordance with the touch operation, and then transfers the image to display control circuit 6 as a display control signal, and the control system 5 appropriately controls the performance of the control system itself and the device equipped with the touch panel. Display control circuit 6 generates a display signal in accordance with the display image that is transferred as the display control signal, and thereby displays the image on liquid crystal display device 1.

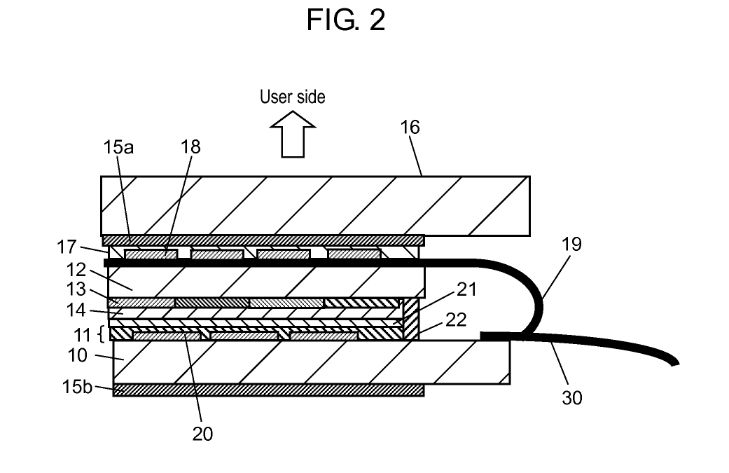

FIG. 2 is a cross-sectional view of the configuration of the liquid crystal display device having the touch panel function according to the embodiment of the technology. It is noted, however, that FIG. 2 shows only major constituent elements of the liquid crystal display device having the touch panel function, and omits the other elements including a backlight. Moreover, the description is made using the case of a liquid crystal display device of an In-Plane Switching type (IPS type), in which common electrodes and pixel electrodes for each pixel are arranged on the inner side of one of a pair of substrates which face each other and interpose a liquid crystal therebetween.

In FIG. 2, on light-transmissive substrate 10, also serving as the touch panel substrate, of the liquid crystal display device, the common electrodes and a plurality of light-transmissive pixel electrodes disposed for each pixel are formed and arranged in a matrix. Moreover, on light-transmissive substrate 10, a plurality of switching thin-film transistors (TFTs) are formed to perform ON-OFF switching of a signal voltage applied to each pixel electrode, which configures active-matrix electrode part 11.

Light-transmissive substrate 12 is disposed on the user side to face light-transmissive substrate 10, with a gap therebetween. On the inner surface of light-transmissive substrate 12 on the user side, color filter layer 13, which is composed of three primary colors, i.e. R (red), G (green), and B (blue), corresponding to the pixels configured with the pixel electrodes, is formed. Between light-transmissive substrate 10 and light-transmissive substrate 12, a liquid crystal material is sealed to form liquid crystal layer 14. Moreover, polarizing plate 15a is disposed on the user side of light-transmissive substrate 12, while polarizing plate 15b is disposed on the back side of light-transmissive substrate 10, i.e. on the side on which the backlight is disposed, which thereby configures the liquid crystal display device.

On polarizing plate 15a, light-transmissive substrate 16 is attached to provide a function of protecting liquid crystal display device 1 from cracks and the like.

In the embodiment, on the back side of light-transmissive substrate 16, light-transmissive flexible film 19 serving as the touch panel substrate is disposed to be sandwiched between light-transmissive substrate 12 and polarizing plate 15a. On light-transmissive flexible film 19, adhesive layer 17 is disposed and a plurality of light-transmissive transparent electrodes 18 are disposed at intervals. Moreover, the plurality of transparent electrodes 18 are formed on the surface on the user side of light-transmissive flexible film 19, thereby configuring detection electrodes YP1, YP2 . . . , i.e. the one of the pair of the coordinate detection electrodes. Light-transmissive flexible film 19 and polarizing plate 15a on the light-transmissive substrate 16 side are bonded with each other via adhesive layer 17 that has a high optical transmittance. Adhesive layer 17 also fills a step height between transparent electrodes 18 and polarizing plate 15a so as to provide a function of reducing the visibility of transparent electrodes 18.

It is noted, however, that adhesive layers to bond between light-transmissive flexible film 19 and light-transmissive substrate 12, and between polarizing plate 15a and light-transmissive substrate 16 are ones that are commonly used in typical liquid crystal display devices; therefore, they are omitted and not shown in the Figure.

Moreover, electrode part 11 formed on light-transmissive substrate 10 includes pixel electrodes 20 of liquid crystal display device 1 and light-transmissive transparent electrodes 21 serving as the common electrodes. A plurality of transparent electrodes 21 are formed, at intervals, to face and intersect with transparent electrodes 18 in a matrix. Transparent electrodes 21 configure drive electrodes XP1, XP2 . . . , i.e. the other of the pair of the coordinate detection electrodes of the touch panel. Note that, in order to increase the detectability of touch by reducing their resistance, transparent electrodes 21 may be accompanied with opaque metal bus-lines (not shown) which run in parallel with the transparent electrodes. In addition, a space between light-transmissive substrate 10 and light-transmissive substrate 12 is sealed with seal member 22 that is formed at peripheral portions of light-transmissive substrates 10 and 12.

That is, in the embodiment, between transparent electrodes 18 on flexible film 19 and transparent electrodes 21 serving as the common electrodes of liquid crystal display device 1, an electrostatic-capacitive coupling is formed via dielectric elements including: liquid crystal layer 14, color filter layer 13, light-transmissive substrate 12, and flexible film 19. Moreover, the touch panel of the electrostatic-capacitive coupling type is configured with flexible film 19 on which transparent electrodes 18 is formed, light-transmissive substrate 10 on which transparent electrodes 21 is formed, following elements including liquid crystal layer 14, color filter layer 13, light-transmissive substrate 12 that are disposed between the flexible film 19 and the light-transmissive substrate 10, and light-transmissive substrate 16 as well as adhesive layer 17.

Here, light-transmissive substrates 10, 12, and 16 may employ a glass substrate, a resin substrate, or the like. The glass substrate includes an inorganic glass, such as a barium borosilicate glass and a soda glass, and a chemically tempered glass. The resin substrate is configured with a resin film including: polyether sulfone (PES), polysulfone (PSF), polycarbonate (PC), polyarylate (PAR), and polyethylene terephthalate (PET).

Transparent electrodes 18 and 21 are configured with electrically-conductive thin films with a thickness of 50 nm to 200 nm. The thin films may employ a light-transmissive, electrically-conductive material, such as a metal oxide or a metal sulfide which has a high electrical conductivity, including: ITO, tin oxide, indium oxide, zinc oxide, and a composite oxide composed of indium oxide and zinc oxide, for example. In addition, the thin films may also employ a metal material with an excellent electrical conductivity, such as aluminum, an aluminum alloy, or copper. Moreover, transparent electrodes 18 and transparent electrodes 21 are formed to have a sheet resistance of approximately 40 Ω□.

Note that, in the embodiment, transparent electrodes 21 serving as the common electrodes of liquid crystal display device 1 are employed as the electrodes that configure drive electrodes XP1, XP2 . . . , i.e. the other of the pair of the coordinate detection electrodes of the touch panel. However, instead of transparent electrodes 21, pixel electrode 20 may also be employed as the electrodes.

Moreover, in FIG. 2, flexible substrate 30 is electrically and mechanically coupled with a lower-side end portion of light-transmissive substrate 12, using an anisotropically-conductive bonding material.

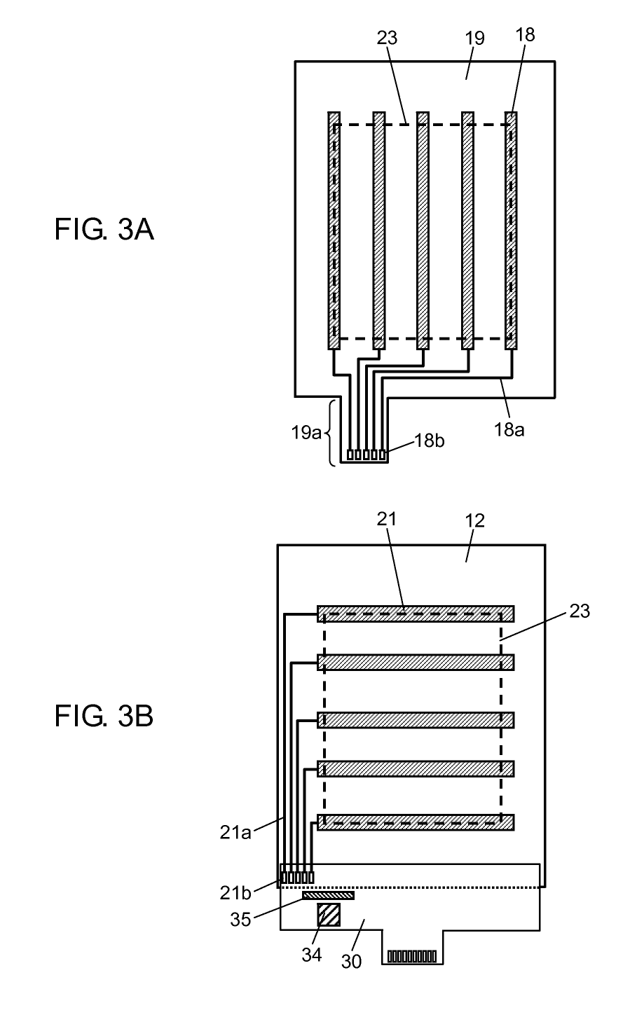

FIGS. 3A and 3B are plan views of an example of an electrode pattern and connection parts which both configure the touch panel, in the liquid crystal display device having the touch panel function according to the embodiment. Specifically, FIG. 3A shows an arrangement structure of the electrodes of flexible film 19. FIG. 3B shows an arrangement structure of the electrodes on the light-transmissive substrate 12 side, and a configuration of flexible substrate 30.

Note, however, that display control circuit 6 and control system 5 of liquid crystal display device 1 are not shown in the Figures because they are mounted on the exterior of the liquid crystal display device. Moreover, in FIG. 3A and 3B, region 23 surrounded by the dashed-line indicates a detection region of the touch panel.

As shown in FIG. 3A, on flexible film 19, the plurality of transparent electrodes 18 are formed at intervals. Flexible film 19 includes extension part 19a that extends from region 23 where transparent electrodes 18 serving as the one of the pair of the coordinate detection electrodes are disposed. Extension part 19a includes wiring parts 18a, one ends of which are electrically coupled with transparent electrodes 18 while the other ends of which are electrically coupled with terminal parts 18b. The wiring parts are configured with a low-electric resistance metal material, such as silver, copper, or aluminum. Terminal parts 18b in the end part of extension part 19a are electrically and mechanically coupled with connection socket 35, serving as a connection part, disposed on flexible substrate 30 on the liquid crystal display device side. Connection socket 35 is electrically coupled with semiconductor 34 for a touch panel controller, which is mounted on flexible substrate 30.

Here, extension part 19a may employ a material that features a high transparency to visible light and a heat resistance of the degree to which the material can be bonded on the substrate by film laminating. That is, for example, the material is a resin film composed of polyether sulfone (PES), polysulfone (PSF), polycarbonate (PC), polyarylate (PAR), polyethylene terephthalate (PET), polyimide, polyamide, or the like.

Moreover, wiring parts 18a are configured such that at least a part of wiring part 18a is formed on extension part 19a. Wiring parts 18a are configured to have a large thickness enough to prevent the occurrence of a crack and peeling-off when extension part 19a is bent, and also enough to reduce their wiring resistance to a sufficient level. Terminal parts 18b may also employ a metal material with an excellent electrical conductivity, such as aluminum, an aluminum alloy, or copper.

With the configuration described above, extension part 19a of flexible film 19 plays a role of a flexible wiring substrate to couple transparent electrodes 18 to an external electric circuit.

As shown in FIG. 3B, on light-transmissive substrate 12, the plurality of transparent electrodes 21 are formed at intervals. Transparent electrodes 21 are equipped with wiring parts 21a composed of a low-electric resistance metal material, such as silver, copper, or aluminum. Wiring parts 21a are electrically coupled with terminal parts 21b that are formed on the end part of light-transmissive substrate 12, outside of region 23. With the end part of light-transmissive substrate 12, flexible substrate 30 is coupled electrically and mechanically, using the anisotropically-conductive bonding material. On flexible substrate 30, semiconductor 34 for the touch panel controller and connection socket 35 are mounted. Semiconductor 34 incorporates capacitance detection unit 3 and control computing unit 4 of the touch panel. Connection socket 35 is to input the detection signal from transparent electrodes 18 to semiconductor 34 for the touch panel controller.

Moreover, transparent electrodes 21 on light-transmissive substrate 12 are electrically coupled with semiconductor 34 for the touch panel controller, by coupling flexible substrate 30 to terminal parts 21b, electrically and mechanically, using the anisotropically-conductive bonding material.

With the configuration described above, liquid crystal display device 1 is electrically coupled with display control circuit 6 via flexible substrate 30, and control system 5 is electrically coupled with semiconductor 34 for the touch panel controller via flexible substrate 30.

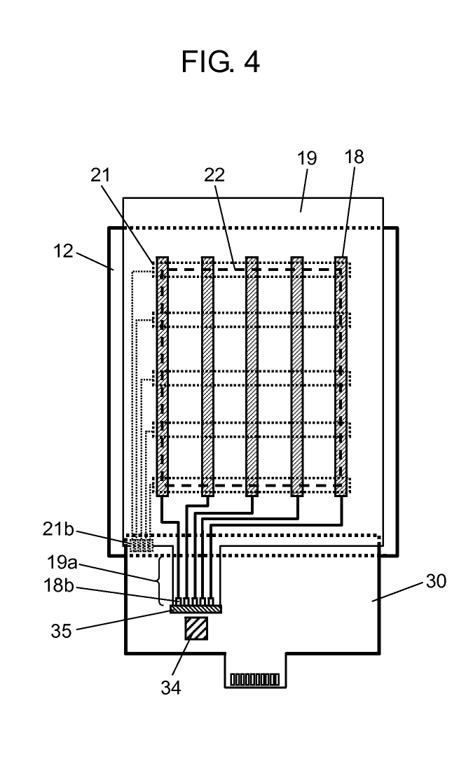

FIG. 4 is a plan view of a state of assembling of the liquid crystal display device equipped with the touch panel according to the embodiment of the technology disclosed herein. That is, it is a schematic plan view illustrating the state of the assembled ones, i.e. light-transmissive substrate 12 on which transparent electrodes 21 shown in FIG. 3B are formed, and flexible film 19 on which transparent electrodes 18 shown in FIG. 3A are formed.

As shown in FIG. 4, terminal parts 18b formed on the end part of extension part 19a of flexible film 19 are coupled with connection socket 35 on flexible substrate 30 disposed on light-transmissive substrate 12. That is, through the use of extension part 19a as a flexible wiring substrate, transparent electrodes 18 on flexible film 19 are electrically coupled with semiconductor 34 for the touch panel controller, with the semiconductor incorporating capacitance detection unit 3 and control computing unit 4 of the touch panel.

In this way, in the embodiment, flexible film 19 on which transparent electrodes 18 serving as the one of the pair of the coordinate detection electrodes are formed, plays a role of the flexible wiring substrate used for the coupling to the external electric circuit.

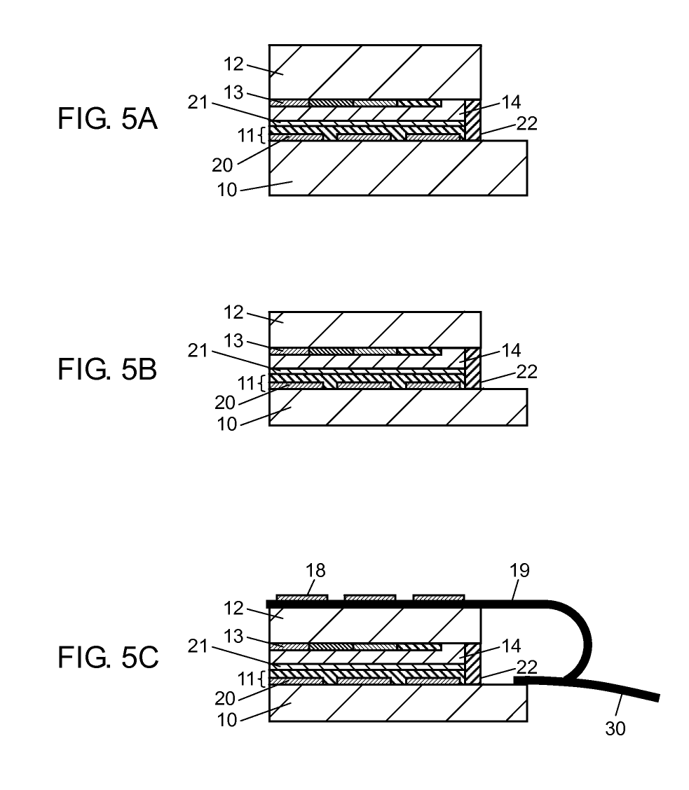

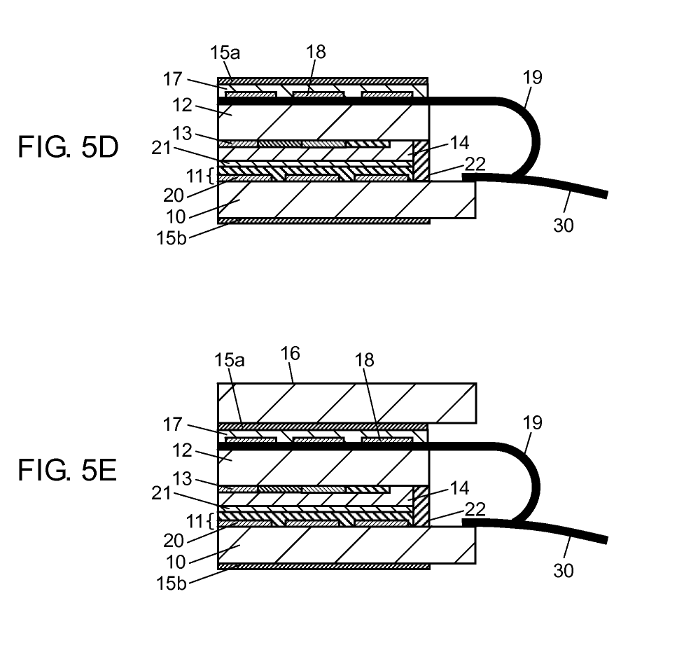

FIGS. 5A to 5E are cross-sectional views illustrating steps of a manufacturing process of the liquid crystal display device equipped with the touch panel according to the embodiment of the technology disclosed herein. Hereinafter, descriptions will be made with reference to FIGS. 5A to 5E.

First, a panel is manufactured as in the case of a manufacturing process of the panel of a typical liquid crystal display device. In this step, the display region is divided into a plurality of regions, and transparent electrodes 21 are made capable of being coupled with each other within each of the regions, so that transparent electrodes 21 can be employed as the one of the pair of the coordinate detection electrodes.

After the panel has been manufactured as shown FIG. 5A, light-transmissive substrates 10 and 12 are subjected to chemical etching with hydrogen fluoride for polishing (slimming) the surfaces of light-transmissive substrates 10 and 12 as shown in FIG. 5B.

On the other hand, another step is performed to form transparent electrodes 18 on flexible film 19. In this step, flexible film 19 composed of PES, for example, is formed into the shape shown in FIG. 3A. Then, a transparent conductive thin film such as an ITO film is prepared, by sputtering, on the surface of the flexible film. Then, the thin film is subjected to patterning by photolithography to form transparent electrodes 18, wiring parts 18a, and terminal parts 18b, as shown in FIG. 3A.

After that, as shown in FIG. 5C, flexible substrate 30 is electrically and mechanically coupled with the end part of light-transmissive substrate 10, using the anisotropically-conductive bonding material, with the flexible substrate incorporating semiconductor 34 for the touch panel controller and connection socket 35 which both have been manufactured in different steps. The step of coupling flexible substrate 30 using the anisotropically-conductive bonding material is as follows. The anisotropically-conductive bonding material is applied to the end part of light-transmissive substrate 10 or to the part of flexible substrate 30 where the terminal parts are formed, followed by heat-press bonding under a predetermined applied temperature and pressure. In addition, flexible film 19 on which transparent electrodes 18 are formed is bonded to light-transmissive substrate 12.

After that, as shown in FIG. 5D, polarizing plate 15b is bonded on the back side of light-transmissive substrate 10. In addition, after alignment of polarizing plate 15a, polarizing plate 15a is bonded to flexible film 19 using light-transmissive adhesive layer 17, as shown in FIG. 5D.

Note that, before the bonding using adhesive layer 17, adhesive layer 17 may be prepared with a liquid adhesive material or a sheet-shaped adhesive material. Moreover, the bonding process may be one of the following two: One is that, after adhesive layer 17 has been formed on the polarizing plate 15a side of the liquid crystal display device, flexible film 19 on which transparent electrodes 18 are formed is bonded to the polarizing plate. The other is that, after adhesive layer 17 has been formed in advance on flexible film 19 on which transparent electrodes 18 are formed, polarizing plate 15a is bonded to flexible film 19.

Then, as shown in FIG. 5E, after alignment of light-transmissive substrate 16 with respect to the liquid crystal display device provided with polarizing plate 15a, the aligned both are bonded to each other with a light-transmissive adhesive. This completes the finished device.

It is noted, however, that the steps of FIGS. 5A to 5E are nothing more than an example, and the order of all the steps is not limited to the example.

Note that, in the case where the common electrodes are coupled to form a common electrode group and are employed as the drive electrodes of the touch panel, the touch panel can be driven by time-sharing between a display period of the liquid crystal display and a coordinate-detecting period of the touch panel, with the backlight being turned off during the coordinate-detecting period. Moreover, the drive voltage for the coordinate detection may be made as a high frequency signal. This allows the driving of the coordinate detection, with the display of the liquid crystal being held even during the coordinate-detecting period.

On the other hand, in the case where the pixel electrodes are employed as the drive electrodes of the touch panel, the touch panel can be driven by time-sharing between the display period of the liquid crystal and the coordinate-detecting period of the touch panel, with the backlight being turned off during the coordinate-detecting period.

Now, descriptions will be made regarding the case where transparent electrodes 18 are not disposed on flexible film 19, but are formed directly on light-transmissive substrate 12.

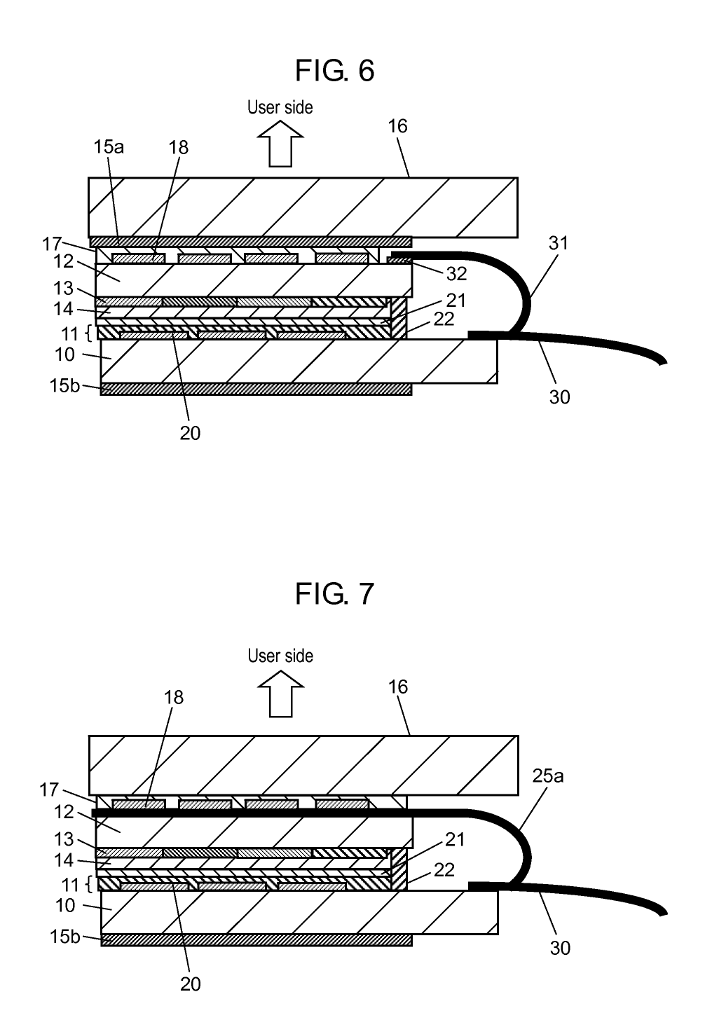

FIG. 6 is a cross-sectional view of an exemplified configuration in which the transparent electrodes are formed directly on light-transmissive substrate 12. In FIG. 6, constituent elements the same as those shown in FIG. 2 are designated by the same numerals and symbols, and their explanations are omitted. In this case, because transparent electrodes 18 are formed directly on light-transmissive substrate 12, the coupling between transparent electrodes 18 and semiconductor 34 (not shown) for the touch panel controller requires that flexible wiring substrate 31 be coupled with light-transmissive substrate 12. For this reason, as shown in FIG. 6, on the end part of light-transmissive substrate 12, terminals 32 to which flexible wiring substrate 31 is coupled are necessary.

On the other hand, on the light-transmissive substrate 10 side, flexible substrate 30 is coupled there. Accordingly, terminals 32 of light-transmissive substrate 12 need to be disposed at a position above seal member 22, which requires that flexible wiring substrate 31 be coupled at the position above seal member 22. In this case, since flexible wiring substrate 31 is coupled using an anisotropically-conductive bonding material, the flexible wiring substrate is subjected to applied temperatures and pressures during the coupling process. This causes local heating and pressing of seal member 22, resulting in possible phenomena including a deformation of seal member 22 and a crack of light-transmissive substrate 12.

Moreover, light-transmissive substrate 10 and light-transmissive substrate 12 are each required to be made thick enough to withstand the heating and pressing process for seal member 22. This makes it difficult to reduce the total depth of the touch panel-integrated liquid crystal display device.

In accordance with the embodiment, compared to the structure shown in FIG. 6, there is no need for increasing the strength of light-transmissive substrate 10 and light-transmissive substrate 12. Therefore, it is possible to employ smaller thicknesses of light-transmissive substrate 10 and light-transmissive substrate 12. In addition, even with flexible film 19 being interposed therein, the touch panel-integrated liquid crystal display device can be made totally thinner in depth. Moreover, the specific gravity of flexible film 19 is generally smaller than that of the light-transmissive substrate, which allows a reduction in weight as well of the liquid crystal display device. Furthermore, seal member 22 between light-transmissive substrate 10 and light-transmissive substrate 12 is not subjected to the local heating and pressing, which eliminates possible problems such as the deformation of seal member 22. In addition, it is possible to omit flexible wiring substrate 31 and its coupling process, resulting in a reduction in costs for materials and processes.

As described above, the input device according to the embodiment is one that is disposed on the user side of the display device, and that includes the pair of the coordinate detection electrodes which are disposed to face each other via the dielectric elements. One of the pair of the coordinate detection electrodes is disposed on the flexible film which is bonded on the surface on the user side of the display device. Electrodes of the display device serve as the other of the pair of the coordinate detection electrodes. The flexible film includes the extension part that extends from the detection region where the one of the coordinate detection electrodes is disposed. The extension part includes the wiring parts which electrically couple to the coordinate detection electrodes and electrically and mechanically couple to the connection part disposed in the display device.

This configuration eliminates the need of flexible wiring substrate 31 to couple the one of the pair of the coordinate detection electrodes to the detection circuit, and the need of the coupling process of the flexible wiring substrate. Accordingly, the sealing area of the display device is not subjected to thermal and mechanical stresses, resulting in a significant decrease in occurrence of defects in manufacturing the devices. In addition, this allows an improved reliability of the device as well as reduced costs of the materials.

Moreover, flexible film 19 does not require the coupling process using the anisotropically-conductive bonding material, which allows its material choice with visible light transmittance as the highest priority.

Note that, the embodiment according to the technology disclosed herein has been described using the liquid crystal display device as an example; however, the technology is also applicable to other devices, such as organic LED display devices and electronic-paper display devices, which are configured with an optical control element sealed between two substrates.

That is, concerning the display-device-integrated input device that includes the pair of the coordinate detection electrodes, with the one of the pair using the pixel electrodes of the display device on a shared basis, it goes without saying that the technology described in the present description is also applicable to other embodiments which optionally undergo changes and modifications, replacements, additions, omissions, or the like, and provides the same advantages.

### Other Exemplary Embodiments

As described above, the embodiment has been described as an exemplified implementation of the technology disclosed herein; however, the technology disclosed herein is not limited to the exemplified implementation, and is also applicable to other embodiments which optionally undergo changes and modifications, replacements, additions, omissions, or the like.

Now, other embodiments will be collectively described hereinafter.

FIG. 7 is a cross-sectional view illustrating a configuration of a liquid crystal display device equipped with a touch panel according to another embodiment of the technology disclosed herein. As shown in FIG. 7, the electrodes for detecting the coordinates may be formed on flexible film 25a with a polarizing function. This case has no need for polarizing plate 15a shown in FIG. 2, resulting in a further reduction in depth of the device. In addition, the bonding process of polarizing plate 15a is omitted, which allows an improved reliability of the device as well as reduced costs of the materials.

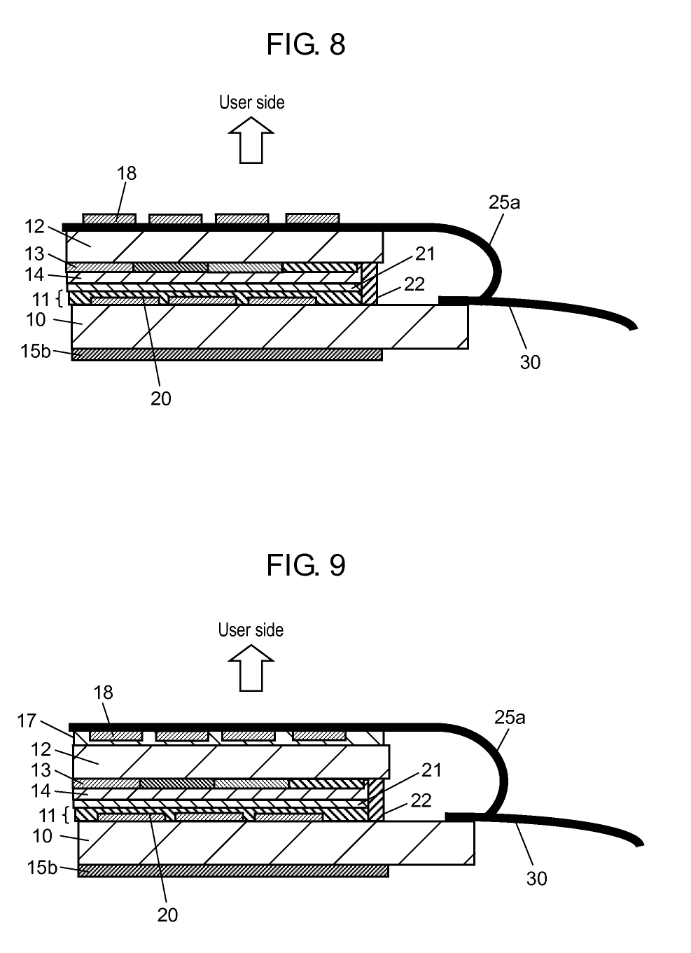

FIG. 8 is a cross-sectional view illustrating a configuration of a liquid crystal display device equipped with a touch panel according to still another embodiment of the technology disclosed herein. In the embodiments described above, user's touch operations on the input device are performed on light-transmissive substrate 16 that is disposed on the user side. However, light-transmissive substrate 16 is not necessarily disposed. As shown in FIG. 8, light-transmissive substrate 16 may be absent in the configuration. In this case, transparent electrodes 18 are formed, in a bare state, on the surface on the user side of flexible film 25a, and the user performs touch operations on transparent electrodes 18 and flexible film 25a.

Note that, in the case of transparent electrodes 18 being in a bare state on the surface of the input device, there is a possibility of phenomena such as a breakage of transparent electrodes 18 due to influences of an external impact or a usage environment, and a short circuit among transparent electrodes 18 due to a contact with something conductive. To prevent such phenomena, the in-advance formation of a protecting layer on transparent electrodes 18 is an effective countermeasure.

FIG. 9 is a cross-sectional view illustrating a configuration of a liquid crystal display device equipped with a touch panel according to yet another embodiment of the technology disclosed herein. As shown in FIG. 9, transparent electrodes 18 may be formed on the surface on the light-transmissive substrate 12 side of flexible film 25a, i.e. on the surface of the display device side, and flexible film 25a is bonded with light-transmissive substrate 12. This configuration eliminates the need for light-transmissive substrate 16 and polarizing plate 15a, which allows a further reduction in depth and weight of the liquid crystal display device. In addition, the bonding processes of light-transmissive substrate 16 and polarizing plate 15a are omitted, which allows a significant reduction in costs of the materials and processes.

Note that, in the embodiment, the configuration is such that the common electrodes of the liquid crystal display device are the drive electrodes of the touch panel, while the transparent electrodes formed on the flexible film are the detection electrodes of the touch panel. However, an inverse configuration may also be employed in which the transparent electrodes on the flexible film are the drive electrodes, while the common electrodes of the liquid crystal display device are the detection electrodes.

Moreover, although terminal parts 21b of flexible film 19 are coupled with connection socket 35 on flexible substrate 30, the terminal parts may be electrically coupled with flexible substrate 30 using an anisotropically-conductive bonding material, without using connection socket 35.

As described so far, the embodiments have been presented herein using the accompanying drawings and the detailed descriptions. They are provided for those skilled in the art only to exemplify the subject matter described in the appended claims by referring these specific embodiments. Consequently, among the constituent elements described in the accompanying drawings and the detailed descriptions, there are possibly included not only essential elements for solving the problems but also other inessential ones. For this reason, it should not be acknowledged that these inessential elements are considered to be essential only on the grounds that these inessential elements are described in the accompanying drawings and/or the detailed descriptions. Moreover, it is to be understood that various changes and modifications, replacements, additions, omissions, and the like may be made to the aforementioned embodiments without departing from the scope of the appended claims or the scope of their equivalents.

As described above, the present invention is useful for input devices of the electrostatic-capacitive coupling system.

1. An input device disposed on a display device, the input device comprising a pair of coordinate detection electrodes disposed to face each other via a dielectric element,
wherein,
one of the pair of the coordinate detection electrodes is disposed on a flexible film,
electrodes of the display device serve as the other of the pair of the coordinate detection electrodes,
the flexible film includes an extension part extending from a detection region where the one of the coordinate detection electrodes is disposed, and
the extension part includes wiring parts which electrically couple to the coordinate detection electrodes and electrically and mechanically couple to a connection part disposed in the display device.

2. The input device according to claim 1, wherein the flexible film has a polarizing function.

3. The input device according to claim 1, wherein the one of the pair of the coordinate detection electrodes is formed on a surface on the user side of the flexible film.

4. The input device according to claim 1, further comprising a light-transmissive substrate bonded on a surface on the user side of the flexible film via an adhesive layer,
wherein the dielectric element is formed of constituent material of the display device.

5. The input device according to claim 1,
wherein the one of the pair of the coordinate detection electrodes is formed on a surface on a display device side of the flexible film,
the flexible film is bonded on the surface of the user side of the display device via an adhesive layer, and
the dielectric element is formed of constituent material of the display device.
